(19) United States
(12) Patent Application Publication
(10) Pub. No.: US 2016/0326766 A1
(43) Pub. Date: Nov. 10, 2016

(54) MAGNETIC FENCE COVERING

(71) Applicant: Vance Miceli, Pelham Manor, NY (US)

(72) Inventor: Vance Miceli, Pelham Manor, NY (US)

(21) Appl. No.: 15/149,658

(22) Filed: May 9, 2016

Related U.S. Application Data
(60) Provisional application No. 62/158,093, filed on May 7, 2015.

(51) Int. Cl. E04H 17/06; E01F 7/02; H01F 7/02; E06B 9/24

(52) U.S. Cl. CPC E04H 17/063; E06B 9/24; E01F 7/025; H01F 7/0252

(57) ABSTRACT

A magnetic fence covering is provided for attachment to a fence. The fence covering comprises a substantially planar sheet having spaced apart top and bottom edges and side edges extending therebetween. At least one magnet is fixedly attached to at least one of the top edge, the bottom edge, and the side edges. The at least one magnet preferably comprises a plurality of magnets fixed in proximity to the top edge of the planar sheet and spaced apart between the side edges. The fence covering is attached to the fence by placing the at least one magnet in magnetic contact with a metal portion of the fence. The plurality of magnets may aligned with the fence post or rail along an entire length thereof.

This application claims priority on U.S. Provisional Application No. 62/158,093 filed on May 7, 2015.

### BACKGROUND OF THE INVENTION

1. Field of the Invention

The present disclosure relates to a magnetic fence covering.

2. Description of the Related Art

Fences are known in the art and are used for a myriad of purposes. Fences can be used for security measures, for privacy, or to demarcate a particular area. For instance, a fence can be used to designate a waiting area or to control a waiting line. Fences typically comprise a plurality of spaced apart vertical posts and at least one railing or the like extending between the posts. In order to provide the greatest privacy and security, the fence should have a closely spaced plurality of posts, and/or a closely spaced plurality of rails. In other words, the space between fence components (i.e. rails and posts) should be minimized. However, there are several drawbacks to this type of fence. In particular, these fences are expensive, aesthetically displeasing, and prevent sunlight and airflow from entering the enclosed area.

Fence coverings are known in the art and are used to provide security and privacy to a typical post-and-rail or chain-link fence. Fence coverings are also used as advertisement space and to block wind from entering an enclosed area. Fence coverings are typically comprised of a sheet of plastic, cloth, or the like fixed to a post-and-rail or chain link fence. The fence covering may be permanently affixed to the fence or temporarily fixed to the fence. Temporary fence coverings are generally fixed to the fence by a plurality of snaps or zip ties. There are several drawbacks to snaps and zip ties as a fastening means. For instance, snaps as a fastening means generally required a plurality of tabs extending from at least one side edge of the fence covering with a first snap element fixed to each tab. The tab may be stitched or glued to the fence covering. However, the stich or glue will degrade over time and will need to be replace. Alternatively, the tab may be formed unitarily with the fence covering. However, unitarily-formed tabs will increase the amount of wasted fabric during the manufacture process, thereby increasing the cost of the fence covering. The first snap element on the tab is aligned with a second snap element near the at least one edge of the fence covering. The tab is wrapped around the fence rail so that the first and second snap elements mate. However, fence rails do not have a uniform thickness. Thus, there will be undesirable variation in the height and placement of the fence covering. Moreover, ensuring each snap is properly connected is a time-consuming process.

Zip ties as a means of attaching a fence covering to a fence also have drawbacks. First, the fence covering must be formed with a plurality of grommets near at least one end. Second, each zip tie must be manually fed through the grommet and secured to the fence. Third, to remove the fence covering, each zip tie must be cut thereby increasing the cost and the time necessary to install a fence covering.

In view of the above, an object of the present invention is to provide a cost-effective fence covering that can be quickly and easily installed.

### SUMMARY

A magnetic fence covering is provided for attachment to a fence. The fence covering comprises a substantially planar sheet. The planar sheet may be plastic, fabric, or any other known and suitable material. The planar sheet is preferably flexible, but may have a degree of rigidity. The planar sheet has spaced apart top and bottom edges and side edges extending therebetween.

At least one magnet is fixedly attached to at least one of the top edge, the bottom edge, and the side edges. In the preferred embodiment, the at least one magnet is fixed to the planar sheet in proximity to the top edge. Preferably, the top edge is folded 180° towards the bottom edge and fixed to the planar sheet to define a magnet accommodating space. The top edge may be stitched to the planar sheet, heat sealed, glued, or otherwise adhered thereto. Further, the at least one magnet may be adhesively or otherwise attached to the planar sheet at a position in proximity to the top edge before the top edge is folded towards the bottom edge. Thus, the positioning of the magnets can be controlled.

The at least one magnet preferably comprises a plurality of magnets fixed in proximity to the top edge of the planar sheet and spaced apart between the side edges. The plurality of magnets may also extend along the side edges and the bottom edge. The at least one magnet is preferably a neodymium magnet. However, any other type of magnet may also be used. Further, the at least one magnet may comprise an elongated magnetic strip extending along the top edge, the bottom edge, and/or the side edges.

The fence covering is attached to the fence by placing the at least one magnet in magnetic contact with a metal portion of the fence. Preferably, the plurality of magnets are aligned with the fence post or rail along an entire length thereof.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a plan view of a magnetic fence covering attached to a fence.

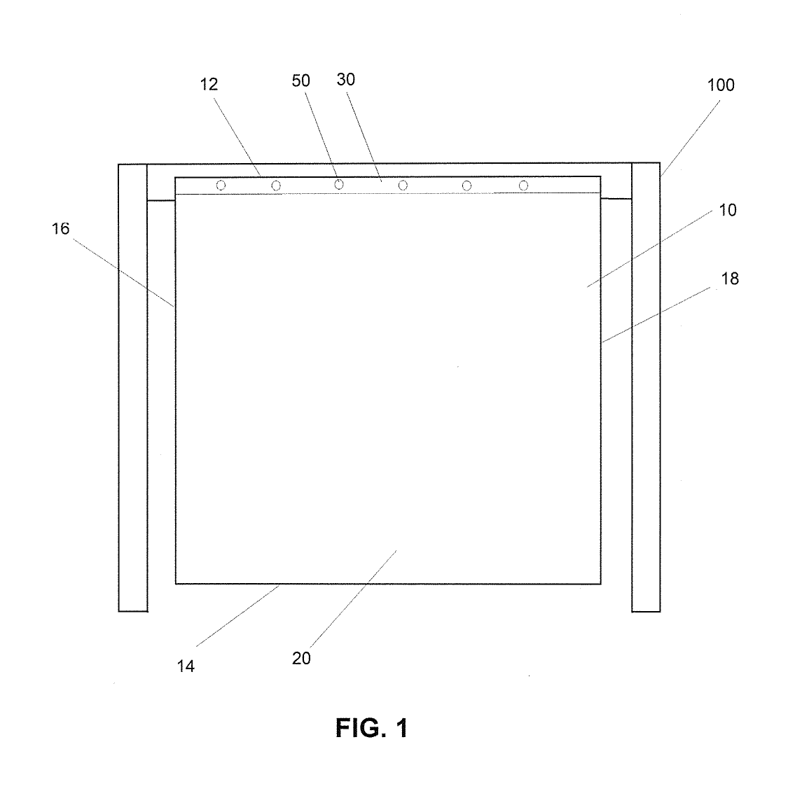

### DETAILED DESCRIPTION

Preferred embodiments of the present disclosure will be described hereinbelow with reference to the accompanying drawings. In the following description, well-known functions or constructions are not described in detail to avoid obscuring the present disclosure in unnecessary detail.

A magnetic fence covering 10 is provided for attachment to a fence 100. The fence covering 10 comprises a substantially planar sheet. The fence covering 10 may be plastic, fabric, or any other known and suitable material. The fence covering 10 is preferably flexible, but may have a degree of rigidity. The fence covering 10 has spaced apart top and bottom edges 12, 14 and side edges 16, 18 extending therebetween. The fence covering 10 is further defined by opposite front and rear surfaces 20, 22.

At least one magnet 50 is fixedly attached to at least one of the top edge 12, the bottom edge 14, and the side edges 16, 18. In the preferred embodiment, the at least one magnet 50 is fixed to the fence covering 10 in proximity to the top edge 12. Preferably, the top edge 12 is folded 180° towards the bottom edge 14 and fixed to the rear surface 22 of the fence covering 10 to define a magnet accommodating space 30. The top edge 20 may be stitched to the rear surface 22, heat sealed, glued, or otherwise adhered thereto. Further, the at least one magnet 50 may be adhesively or otherwise attached to the rear surface 22 at a position in proximity to the top edge 12 before the top edge 12 is folded towards the bottom edge 14. Thus, the at least one magnet 50 can be held in a fixed position.

The at least one magnetic 50 preferably comprises a plurality of magnets 50 fixed in proximity to the top edge 12 of the fence covering 10 and spaced apart between the side edges 16, 18. The plurality of magnets 50 may also extend along the side edges 16, 18 and the bottom edge 14. The at least one magnet 50 is preferably a neodymium magnet. However, any other type of magnet may also be used. Further, the at least one magnet 50 may comprise an elongated magnetic strip extending along the top edge 12, the bottom edge 14, and/or the side edges 16, 18.

The fence covering 10 is attached to the fence 100 by placing the at least one magnet 50 in magnetic contact with a metal portion of the fence. Preferably, the plurality of magnets 50 are aligned with a fence post 102 or a rail 104 along an entire length thereof. The fence covering 10 is preferably aligned vertically so that the front surface 20 or the rear surface 22 abuts the fence. At least one of the front and rear surfaces 20, 22 may include indicia, such as an advertisement, a sports team name, instructions, or any other suitable indicia.

The fence covering 10 may include additional means of attachment to the fence. For instance, the fence covering 10 may be formed with a plurality of eyelets along at least one of the top edge 12, the bottom edge 14, and the side edges 16, 18. Alternatively, four eyelets may be positioned at each of the four corners of the fence covering 10. Zip ties, small lengths of cord, or an elastic may be used to selectively attach the fence covering 10 to the fence 100 in addition to the at least one magnet for safety purposed or to secure the fence covering against theft.

While the disclosure has been shown and described with reference to certain preferred embodiments thereof, it will be understood by those skilled in the art that various changes in form and detail may be made therein without departing from the spirit and scope of the disclosure.

Furthermore, although the foregoing text sets forth a detailed description of numerous embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112(f).

What is claimed is:

1. A fence covering to be removably attached to a fence having at least one magnetic portion, comprising:
a covering member having spaced apart top and bottom edges and first and second side edges extending between the top and bottom edges, and opposed front and back surfaces extending between the top and bottom edges and the first and second side edges;
at least one magnet accommodating space provided in proximity to at least one of the top and bottom edges and first and second side edges; and
at least one magnet accommodated in the at least one magnet accommodating space, wherein
the at least one magnet is in magnetic contact with the at least one magnetic portion of the fence.

2. The fence covering of claim 1, wherein at least one of the top and bottom edges and first and second side edges is folded 180° about the covering member to define the at least one magnet accommodating space.

3. The fence covering of claim 2, wherein the at least one of the top and bottom edges and first and second side edges is fixedly adhered to the covering member to define the magnet accommodating space.

4. The fence covering of claim 1, wherein the at least one magnet comprises a plurality of magnets spaced apart in the at least one magnet accommodating chamber.

5. The fence covering of claim 1, wherein the at least one magnet comprises an elongated magnetic strip extending in the at least one magnet accommodating space.

6. The fence covering of claim 1, further comprising at least one eyelet extending between the front and back surfaces at at least one of the four corners of the covering member.

7. The fence covering of claim 6, further comprising at least one zip tie extending through the at least one eyelet and connecting the covering member to fence.

8. The fence covering of claim 1, wherein the at least one magnet is a neodymium magnet.

9. A fence, comprising:
at least first and second spaced apart vertical posts;
at least one transverse member extending between the at least first and second vertical posts;
at least one first magnetic element fixed to at least one of the first and second vertical posts and at least one transverse member;
a covering member removably attached to at least one of the first and second vertical posts or at least one transverse member, the covering member having spaced apart top and bottom edges and first and second side edges extending between the top and bottom edges, and opposed front and back surfaces extending between the top and bottom edges and the first and second side edges;
at least one magnet accommodating space provided in proximity to at least one of the top and bottom edges and first and second side edges; and
at least one second magnet accommodated in the at least one magnet accommodating space, wherein
the at least one second magnet is in magnetic contact with the at least one first magnetic element.
